(19) United States
(12) Patent Application Publication
(10) Pub. No.: US 2019/0219817 A1
(43) Pub. Date: Jul. 18, 2019

(54) Diffusion Product that will De-Pixilate an LED Source

(71) Applicant: Rosco Laboratories Inc., Stamford, CT (US)

(72) Inventor: Anne Hunter, Round Rock, TX (US)

(21) Appl. No.: 16/250,374

(22) Filed: Jan. 17, 2019

Related U.S. Application Data
(60) Provisional application No. 62/618,334, filed on Jan. 17, 2018.

(51) Int. Cl. G02B 27/00; G02B 5/02; B29C 59/02; B29C 59/04; B29C 33/38

(52) U.S. Cl. CPC G02B 27/0025; G02B 5/0268; G02B 5/0215; G02B 5/0231; B29C 2059/023; B29C 59/022; B29C 59/04; B29C 33/3842; G02B 5/0252

(57) ABSTRACT

The disclosed system is a method for manufacturing a film. The system comprises a computer, which has a microstructure design, and sends this design to a laser. The laser etches the design into a roller. The roller is then rolled over a liquid film to emboss the microstructures into the film. The film is then solidified to obtain a film with microstructures useful for diffusing light.

### TECHNICAL FIELD

This disclosure relates to a method of creating beam shaping for light/diffusors, generally used to diffuse multiple LED and standard light sources into a homogenous light source, while shaping the beam of the light.

### BACKGROUND

Light shaping and diffusion have been important in lighting effects, especially since the invention of the LED. Analog light sources create a broader more homogenous light beam, and this is what is still desired from LEDs that are cheaper and more energy efficient. However, creating giant LEDs is not feasible. Instead, an array of LEDs is used to create a larger light source. In order to prevent gradients where the light sources originate, a diffusor will blend the light from multiple LEDs into a homogenous light source.

Holographic diffusors are a common type of diffusor that can be made from polycarbonate and/or other materials having holographic diffusing properties etched or otherwise embossed onto the surface of the material(s). Holographic diffusors will cover multiple LEDs to make the plurality of LEDs look like a continuous light source. This is beneficial in a variety of different uses, changing what looked like a series of dots into a homogenous line or plane of light. For photography lighting, this is important, as a smoother light source provides more balanced light.

Holographic diffusors are typically made of polycarbonate structures, however, other materials may be used. By embossing or debossing a holographic pattern onto a polycarbonate film or rigid sheet, light will be distributed in multiple directions. Through careful manufacturing, the angles can be limited and the holographic diffusor will release light in a pseudo-random distribution that will create a homogenized light. This helps eliminate hotspots and uneven light distributions typically caused by an array of singular light sources. This distribution can also be engineered for different pre-determined angles. These angles may be symmetrical or non symmetrical, have different angular distributions in both directions.

Present holographic diffusors may vary from batch to batch. When creating the holographic patterns on polycarbonate or other material, for example, each batch is not made in likeness to the previous batch. This causes a product where you are never sure what you are going to get. Inconsistency in extruded (non UV cast or energy cured cast) holographic structures is due to the variations in extrusion. Changing environmental conditions can cause variations in operator set up which leads to said inconsistencies. Differences in the raw materials used batch to batch also causes variations in the extruding structure. Typically, extruded structures are larger than 10p and are thus not affected by small variations. However when manufacturing holographic diffusors/beam shapes, there are different structures that can be affected by changes of less than 200 nm. For extruded products, these tolerances are simply too small. Therefore, it is advantageous to develop a diffusor and beam shape that has a higher tolerance for slight defects.

Holographic diffusors/beam shapers also suffer from color fringing and color shifting. Concurrently with the diffusion of a beam comes diffraction of the same beam. Since the white light is diffracted in multiple directions, the colors get separated as each color will change angle slightly differently. This occurs as a result of prismatic effects, when white light falls across structures less than about 10μ and in particular, structural sections of the structures that are less than about 700 nm. Thus, at the edges of the diffusor/beam shapers there will be color aberrations, which are unwanted in the field. These colors appearing at the edges of the diffusor are called color fringes. Color shifting occurs when the polycarbonate warms the color temperature of the light. By creating a more translucent diffusor, color shifting of light can be prevented.

Etching microstructures into the top of a polycarbonate film can cause both color fringing and color shifting. Color fringing occurs because the etchings are not deep enough to mask the diffraction. Color shifting occurs through a loss of energy in the medium. Some diffusors/beam shapers are embossed with a different material on top of the polycarbonate. However, the same problems remain.

### SUMMARY

The present disclosure solves many of the problems with the current state of holographic diffusors. The system provides a diffusion and beam shaping product that is capable of de-pixilating light sources, for example, LED or tungsten sources, without color shifting or color fringes. This prevents the LEDs from having hot spots, and instead provides a homogenous display. Further, this diffusion and beam shaping product is capable of producing predictable effects due to the larger structures. In the past, diffusors on the market were inconsistent batch to batch.

Semi-Rigid polycarbonates are beneficial in the field because they provide a quality light dispersion with added flexibility in how they are used. They can be easily cut, or otherwise manipulated into any size or shape. The films may be made out of a plurality of materials including: rigid polycarbonates, such as ones greater than 10 mil., acrylics, or polyester. Since the entire film provides for light dispersion, piecing it into sections does not detract from the quality of the diffusion. Using cut-able polycarbonate film and/or other materials, it is easier to order all one's films at once, instead of sizing out every aspect needed and waiting for a manufacturer to send all of the correct parts.

Embossing the film with computer-generated microstructures is beneficial to diffusors/beam shapers as it creates a predictable effect. The light can be directed exactly as desired to prevent hotspots, fringing, or other negative effects. In prior ways of creating micro-structures, such as UV molding, each batch would come out differently. This would leave the user wondering how successful this batch would be. Instead, with an embossed polycarbonate film, each batch can be identically reproduced.

Further, to prevent color fringes typical with holographic diffusors, the present disclosure has diffusing structures of a greater depth. While holographic diffusion structures are kept at a depth of about 200 nm to 2 microns, this film made by the present method has structures ranging from about 100 to about 250 microns deep.

To create a polycarbonate film having such structures, the structures must be designed on a computer program. Next, the program or computer sends the desired structures to a laser, which etches the structures, or the inverse of the structures, to a roller. A liquid polycarbonate is then run under the roller and is chilled to solidify the structures. The roller embosses the microstructures to the liquid polycarbonate, and when solidified the polycarbonate retains these structures. In some embodiments, additives may be set into the polycarbonate to keep the diffusor fire-proof or to import other qualities.

### BRIEF DESCRIPTION OF THE DRAWINGS

FIG. 1 is a sample view of diffusion of light.

FIG. 2 is a perspective view of the system.

### DETAILED DESCRIPTION

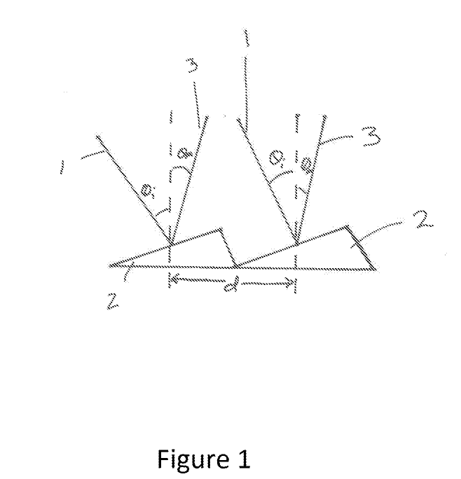

In FIG. 1 an up-close look at a beam shaping diffusor is portrayed. For a distance between microstructures, “d” less than about 8 microns, the visible light spectrum will have diffractive characteristics. The entrance beams 1 hit the micro structures 2. Upon hitting the microstructures, the beams are diffracted. The angle of incidence Θᵢ, will determine the angles of diffraction Θₘ based on the energy of the light. If the distance between microstructures “d” is not great enough, the split in color will be visible. This can occur in parts of the structures as well as the entire structure.

The entrance light beams 1 will also refract when hitting microstructure 2. This refraction causes a change in the shape of the light beam. It is further possible to design the microstructures 2 such that when the entrance beams 1 move in from the opposite direction, different angles of refraction occurs, which over the entire array of microstructures would cause a different beam shape.

By creating a beam shaping diffusion structure that is considerably deeper than current diffusion structures available, the white light will still be diffused and refracted, but the diffusion structures will be far enough away from the diffraction or prismatic structures that the color fringing effects will no longer be visible. By solidifying the polycarbonate or other material film with the microstructures already embossed into them, it allows the film to retain its translucence and color shifting does not occur.

Creating microstructures with depths of about 50 to 250 microns is done through a roller. A computer designs the structures desired for each sheet of film, wherein the film is made of polycarbonate and/or other materials. The designs are ray traced in a computer program and optimized for the desired result. Each microstructure is designed at a unique angle at which it refracts the light. By selectively placing different angled microstructures throughout the film, a unique beam shape can be obtained. Further, due to the reversible nature of the film, a specific set of microstructures can be designed such that it creates a different beam shape when the film is reversed over the light source.

A text file is created with all of the geometry of the desired structure with X, Y and Z axes every few microns. These text files are then converted to graphic files in a separate, custom software program. The Z-axis values are converted from text files to gray scale files that the laser rip software can interpret. The Z-axis is defined as an intensity relative to the rubber being engraved to engrave to the proper depth (the desired depth from the software). The laser is then calibrated to keep the depth axis accurate relative to the gray scale file. A “white” pixel at 100% may indicate a depth (z-axis) of 150 microns, for example. According to this scale, a 50% gray scale will equal a depth of 75 microns. In other embodiments of the gray scale file, the relationship may not be linear. Each pixel represents a data point or laser burn. The laser can then ablate the rubber directly creating three dimensional shapes.

It is important to note that one of the advantages to this system of direct ablation is that the tooling cost is significantly less than traditional holography. It is also important to note that the rolls can be made without seams, which is impossible with holography. The relative costs of a large, stepped roll in holography are more than 20× the cost of the direct laser ablation. The holography will also always have shim lines or seams that can show up in the diffusion projection.

The computer then laser etches microstructures onto an intermediary, such as a substrate, which is attached to the roller. In other embodiments, the laser etches the microstructures directly onto the roller. Liquid polycarbonate, or other material, is passed under the roller, and the roller embosses these structures onto the material. When the material solidifies it retains these microstructures. This is further advantageous because by rolling the microstructures onto the film instead of etching or applying another material on-top, the polycarbonate film retains translucence.

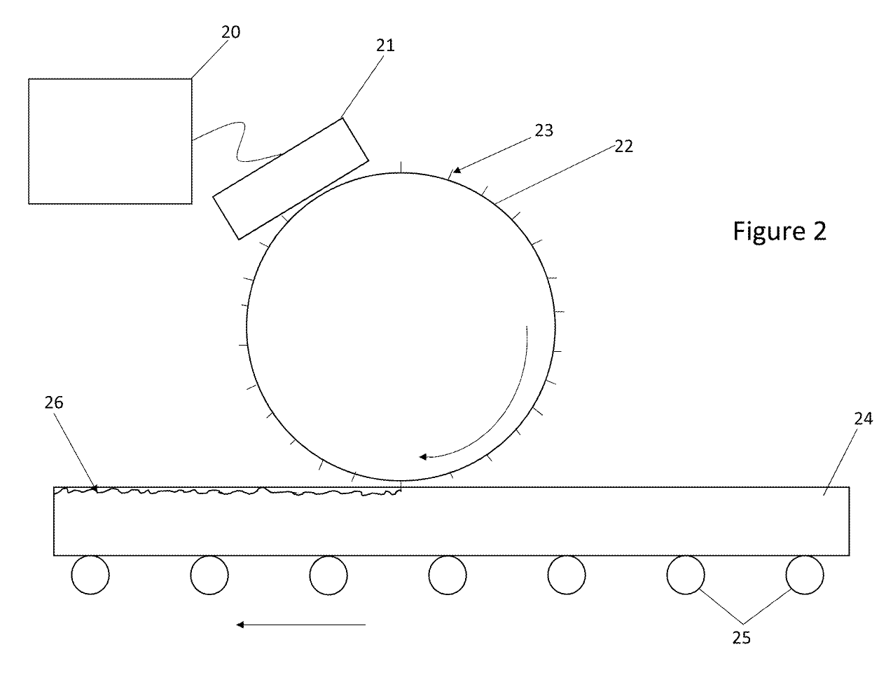

One embodiment of the method of manufacture is portrayed in FIG. 2. In this embodiment, computer 20 sends a design of microstructures to laser 21. The laser embeds these microstructures onto the roller 22. These microstructures 23 may be inverse to what will appear on the polycarbonate film 24. As the polycarbonate film 24 is pushed under the roller by a mechanism 25, microstructures 26 are left on the polycarbonate film 24. As the polycarbonate film 24 is passed under the roller 22, it is in liquid form. This prevents solid on solid etching, which can cause damage to the top of the film, or otherwise ruin the translucence of the film. However, the polycarbonate film 24 is solidified with the microstructures 26 embossed into the film. Roller 22 may contain a cooling liquid or other source of cooling to accelerate the cooling process. By adjusting the cooling temperature of roller 22, the gloss level of the polycarbonate film 24 is adjusted.

In other embodiments of the invention, not all the components are necessary. In one embodiment, the rollers are premade and do not require a computer or laser etching. In another embodiment, the roller could be a stamp which embosses the entire film 24 at once. In another embodiment, the microstructures 23 are varied throughout the roller to create unique effects. Further, other materials besides polycarbonate may be used to compose the film, for example and acrylic or polyester.

In another embodiment, the roller is used on a polycarbonate that has already solidified. While this embodiment is not preferable, it could be done to simplify the manufacturing process. In a different embodiment, it is not the roller which directly causes the solidification, but instead, the system is designed to solidify the polymer simultaneously or about simultaneously with the roller entering the polycarbonate liquid. In some embodiments the film material is a gel, and solidifies over time. In other embodiments the roller can provide a cooling to the liquid film which allows the film to freeze with the microstructures intact. Other known methods of cooling the liquid film may also be used. By changing the temperature of the roller, or other cooling device, the gloss level on the surface of the solidified film will change. This allows customization to the gloss levels of the film depending on the desired outcome.

Solidification of the film while still in contact with the roller, or soon after ending contact with the roller is beneficial in helping to prevent the microstructures from morphing before solidification. In a similar fashion, the manufacture process could happen very slowly. For example, a small section of the liquid film under the roller at a given time, and upon that section's solidification the roller is then moved to the next portion of the film, until a desired length is achieved. In this embodiment, there may be a heat source on the liquid side of the film and a cooling source on the solidified section of the film.

In one embodiment, the microfilm is reversible for different effects. Facing the film with a first side against the light would lead to a greater transparency in the film, but with less diffusion. Facing a second side of the film against the light would lead to greater diffusion, but with less transparency. This embodiment allows the user to better customize the film for different purposes.

In a preferred embodiment, flame retardant additives are added to the polycarbonate film. Especially when exposed to light for an extended period of time, the polycarbonate has a chance to catch on fire. The flame retardant additives will prevent the polycarbonate from catching fire. In other embodiments, different additives could be added to the liquid polycarbonate. These could, for example, be dyes or other filter like effects, which change the filters overall effect on the light.

It should be understood to a person of ordinary skill in the art that different configurations of the transformer apparatus are possible. For example, the design layout of the transformer apparatus may differ from those shown in the Figures without departing from the scope and spirit of the present teachings.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system of manufacturing a light beam shaping diffusor comprising:
a roller;
a pattern of three dimensional microstructures directly ablated on to a substrate using a laser; and
a liquid film material;
wherein the substrate is attached to the roller;
wherein the liquid film material is passed under the roller; and
wherein after passing under the roller the liquid film is solidified forming a solidified film having the three dimensional microstructures embossed into the solidified film.

2. The system of manufacturing a light beam shaping diffusor of claim 1 wherein:
each three dimensional microstructure is embossed 100 to 250 microns in the film.

3. The system of manufacturing a light beam shaping diffusor of claim 1 wherein,
the pattern of three dimensional microstructures is generated by a computer and the pattern of three dimensional microstructures is displayed as an image file.

4. The system of manufacturing a light beam shaping diffusor of claim 3 wherein,
the image file is converted from a text file indicative of three dimensional microstructures.

5. The system of manufacturing a light beam shaping diffusor of claim 3 wherein,
the pattern of three dimensional microstructures etched onto the substrate provides a seamless roller.

6. The system of manufacturing a light beam shaping diffusor of claim 1 wherein,
the liquid film is liquid polycarbonate.

7. A method of manufacturing a seamless diffusor comprising:
creating a text file indicative of the desired structure of three dimensions of a set of microstructures;
converting the text file into an image file;
interpreting the image file, by a laser;
laser etching the set of microstructures onto a substrate to create an ablated microstructure on the surface of the substrate;
attaching the substrate to the roller
running the roller along a surface of a liquid film; and
freezing the liquid film such that the surface of the liquid film is embossed with the set of microstructures laser etched into the roller.

8. The method of manufacturing a seamless diffusor of claim 7 wherein;
the roller provides a seamless set of microstructures.

9. The method of manufacturing a seamless diffusor of claim 7 wherein;
the liquid film is a polycarbonate film.

10. The method of manufacturing a seamless diffusor of claim 7 wherein;
the substrate is rubber.

11. The method of manufacturing a seamless diffusor of claim 7 wherein;
the substrate is silicone.

12. The method of manufacturing a seamless diffusor of claim 7 wherein;
the image file is a gray scale image, wherein the percent of the gray scale is indicative of a depth of a microstructure.

13. The method of manufacturing a seamless diffusor of claim 12 wherein;
each pixel of the image file corresponds to a laser burn.

14. The method of manufacturing a seamless diffusor of claim 7 wherein;
each microstructure is 50 to 250 microns deep in the film.

15. A light beam shaper comprising;
a solidified film wherein a temperature at which the film was solidified is indicative of a gloss level on the surface of said film,
a plurality of microstructures embossed into the film by a roller, wherein the microstructures are configured to diffuse and shape a beam of light,
wherein the solidified film is reversible, such that when reversed the microstructures shape the beam of light into a different shape.

16. The system of manufacturing a light beam shaping diffusor of claim 2 wherein the three dimensional microstructures shape a beam of light into a round shape when a first face is facing the beam of light.

17. The system of manufacturing a light beam shaping diffusor of claim 16 wherein the round shape is a different round shape when a second face is facing the beam of light.

18. The system of manufacturing a light beam shaping diffusor of claim 1 wherein the roller contains a cooling liquid which solidifies the liquid film, wherein the temperature of the cooling liquid is indicative of a gloss level on the surface of the solidified film.

19. The system of manufacturing a light beam shaping diffusor of claim 1 wherein the liquid film material contains flame retardant additives.

20. The light beam shaper of claim 15 wherein the microstructures are embossed 100 to 250 microns into the film.
